(19) United States
(12) Patent Application Publication
(10) Pub. No.: US 2022/0314253 A1
(43) Pub. Date: Oct. 6, 2022

(54) TRIGGER SPRAYER WITH AN IMPROVED TRIGGER AND PISTON ASSEMBLY

(71) Applicants: Market Ready, Inc., Round Lake Park, IL (US); Cupcake LLC, New York, NY (US)

(72) Inventors: Brandon Donnelly, New York, NY (US); Kyle Hansen, Hartland, WI (US); Alan Gormley, Blessington (IE); Milan-Bob Patadlas, Talisay City, Cebu (PH); Michael Sawant, Lake Forest, IL (US)

(73) Assignees: Market Ready, Inc., Round Lake Park, IL (US); Cupcake LLC, New York, NY (US)

(21) Appl. No.: 17/712,478

(22) Filed: Apr. 4, 2022

Related U.S. Application Data
(60) Provisional application No. 63/170,670, filed on Apr. 5, 2021.

(51) Int. Cl. B05B 11/00

(52) U.S. Cl. CPC B05B 11/3057; B05B 11/3011

(57) ABSTRACT

A trigger sprayer assembly for dispensing a fluid is provided. The assembly includes an engine having a piston chamber and an outlet passage that is fluidly coupled to the piston chamber, a piston having a plunger and an intermediate portion that extends from the plunger and terminates in an end portion, a trigger lever having a main body and a piston coupling body, and a pair of trigger springs coupled to the main body. Each trigger spring includes a first curved portion, a second curved portion, and a terminating portion. The terminating portions are configured to fit within recesses formed in the engine, and the piston coupling body engages with the end portion. Pivoting the trigger lever from a neutral position to an actuated position compresses the trigger springs and pushes the plunger into the piston chamber to drive fluid into the outlet passage.

### CROSS-REFERENCE TO RELATED PATENT APPLICATION

The application claims the benefit of U.S. Provisional Application Ser. No. 63/170,670, filed Apr. 5, 2021, which is incorporated by reference herein in its entirety.

### FIELD

The present invention relates to an improved trigger sprayer for dispensing liquids and more particularly to a trigger sprayer with an improved trigger and piston assembly.

### BACKGROUND

Trigger sprayer assemblies provide a convenient way to manually dispense many household products and commercial cleaners in a stream, spray, mist, or foam discharge. In some cases, the trigger sprayer includes U-shaped springs that return a trigger lever that operates a piston component to an un-actuated or neutral position after a user has applied an actuating force to the trigger lever. It is known to mold the trigger springs and the trigger lever into a single integral component. If the springs are insufficiently durable to withstand hundreds of applications of an actuating force and subsequently fracture, the entire trigger sprayer becomes unusable. In addition, the amount of resistance provided by the trigger springs as a user applies an actuating force is critical to the successful functioning of the trigger sprayer assembly. For example, trigger springs that provide a large amount of resistance when a user applies an actuating force can result in a trigger sprayer assembly that is difficult and unpleasant to operate. An improved trigger sprayer assembly with durable trigger springs that provide smooth actuation to the user would therefore be useful.

### SUMMARY

In one aspect, the present invention is directed to a trigger sprayer assembly for dispensing a fluid. The trigger sprayer assembly includes an engine, a piston component and a trigger lever component. The engine has a piston chamber and an outlet passage that is fluidly coupled to the piston chamber and leads to the nozzle. The piston has a plunger and an intermediate portion (e.g. piston rod) that extends from the plunger and terminates in an end portion having an oval-shaped opening. The trigger lever component has a main body with squeezable lever, a piston coupling body, and a pair of trigger springs extending from the main body. Each trigger spring includes a first curved portion, a second curved portion, and a terminating portion. The terminating portions are configured to fit within recesses formed in the engine, and the piston coupling body is slidable within the oval-shaped opening on the end portion of the piston. Pivoting the trigger lever from a neutral position to an actuated position compresses the trigger springs and pushes the plunger into the piston chamber to drive fluid from the piston chamber and through the outlet passage to be discharged through the nozzle. The oval-shaped opening at the end portion of the piston enables the force from the trigger lever to be directed more closely along the horizontal axis of the piston even when the trigger connection moves vertically as the trigger lever is squeezed. It also reduces strain on the piston from repeated use. The shape of the springs along with how it is attached to the engine reduces maximum strain along the springs while providing a strong, smooth spring return force.

In another aspect, the present invention is directed to a trigger lever for a trigger sprayer assembly. The trigger lever includes a main body extending from an upper end to a lower end, the lower end being configured to be grasped by a user to actuate the trigger sprayer assembly. The trigger lever further includes a pair of trigger springs extending from the upper end of the main body. Each of the pair of trigger springs includes a first curved portion, a second curved portion, and a terminating portion.

In yet another aspect, the present invention is directed to a piston for a trigger sprayer assembly. The piston includes a plunger configured to slide within a piston chamber and an intermediate portion configured to extend from the plunger and terminate in an end portion. The end portion has an oval-shaped opening formed therethrough.

### BRIEF DESCRIPTION OF THE DRAWINGS

The present invention is described with reference to the following Figures. The same numbers are used throughout the Figures to reference like features and like components.

FIG. 1 is a perspective view of a trigger sprayer assembly according to an exemplary embodiment of the present invention.

FIG. 2 is a side view of the trigger sprayer assembly of FIG. 1.

FIG. 3 is an exploded view of the trigger sprayer assembly of FIG. 1.

FIG. 4 is a perspective view of a trigger lever component used in the trigger sprayer assembly of FIG. 1.

FIG. 5 is another perspective view of the trigger lever component of FIG. 4.

FIG. 6 is a side exploded view of the trigger sprayer assembly of FIG. 1.

FIG. 7 is a perspective exploded view of the trigger sprayer assembly of FIG. 1.

FIG. 8 is a side cross-sectional view of the trigger sprayer assembly of FIG. 1.

FIG. 9 is a side cross-sectional view of the trigger sprayer assembly of FIG. 1 with the trigger lever component in a relaxed position.

FIG. 10 is a side cross-sectional view of the trigger sprayer assembly of FIG. 1 with the trigger lever component in an actuated position.

FIG. 11 is a detail view of the piston and trigger components of the trigger sprayer assembly of FIG. 1 when the trigger lever component is in the relaxed position of FIG. 9.

FIG. 12 is a detail view of the piston and trigger lever components of the trigger sprayer assembly of FIG. 1 when the trigger lever component is in the actuated position of FIG. 10.

FIG. 13 is a top cross-sectional view of the trigger sprayer assembly taken along the line 13-13 of FIG. 9.

FIG. 14 is a front cross-sectional view of the trigger sprayer assembly taken along the line 14-14 of FIG. 13.

FIG. 15 is a perspective view of a piston component that may be utilized in another exemplary embodiment of a trigger sprayer assembly according to the present invention.

FIG. 16 is a side cross-sectional view of a trigger sprayer assembly including the piston component of FIG. 15.

### DETAILED DESCRIPTION

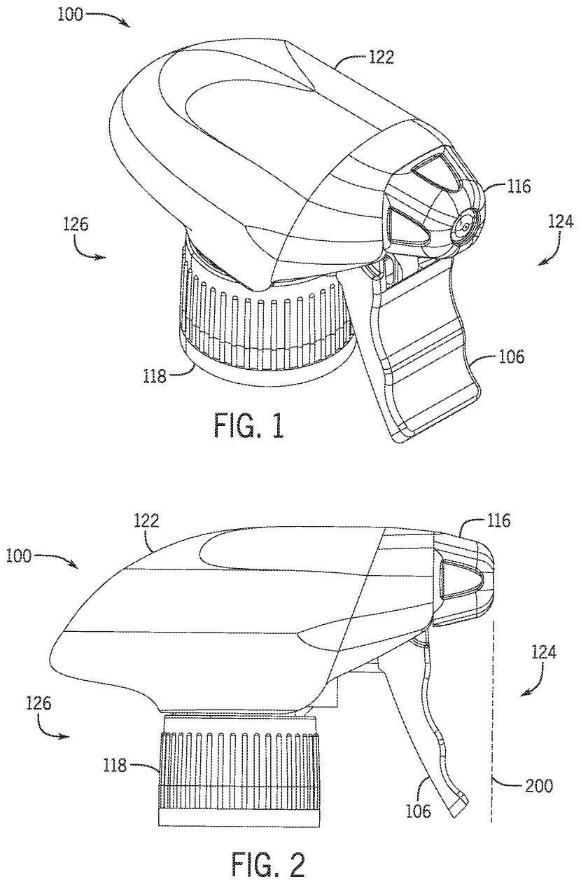

FIGS. 1-3 depict an improved trigger sprayer assembly 100 according to an exemplary embodiment of the present invention. The trigger sprayer assembly 100 may be adapted to dispense a fluid (e.g., cleaning products, industrial products, water, cosmetics, food products) contained within a bottle or container (not shown) in a stream, spray, or mist dispensing pattern. To operate the sprayer assembly 100, a user grips a trigger lever component 106 at a front end 124 of the assembly 100, positioning a thumb around the joint between a neck closure 118 and a shroud 122 at a rear end 126 of the assembly 100. By depressing or squeezing the trigger lever component 106 toward the rear end 126 from a relaxed or neutral position to a depressed or actuated position, fluid from the bottle or container is driven out through a nozzle 116. Advantageously, as depicted in FIG. 2, in the neutral position, the trigger lever component 106 resides entirely to the rear of a plane 200 that is coincident with a front face of the nozzle 116. This arrangement ensures that the trigger sprayer assembly 100 is easier to package, ship, and store than a comparable trigger sprayer assembly in which the trigger lever component extends in front of the plane 200. In this exemplary embodiment, the nozzle 116 is configured to rotate relative to the shroud 122 to permit a user to close or open a fluid passage that terminates at the nozzle 116, and to select a desired dispensing pattern (e.g., stream, spray, mist).

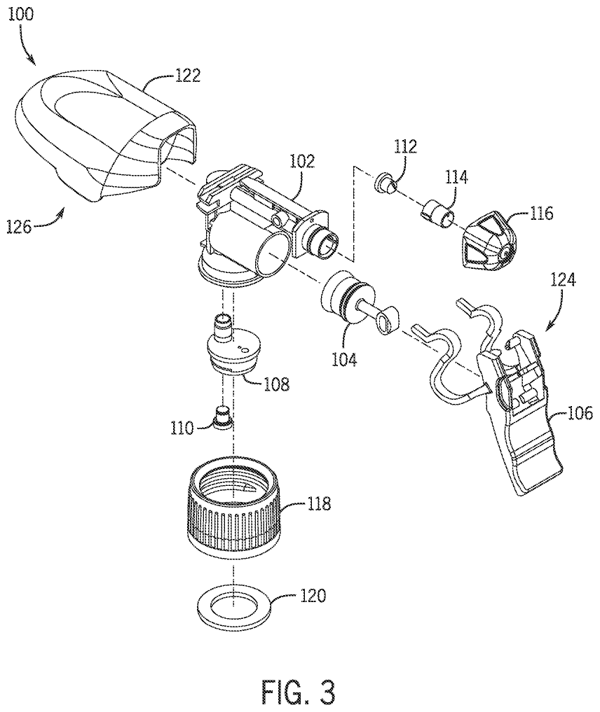

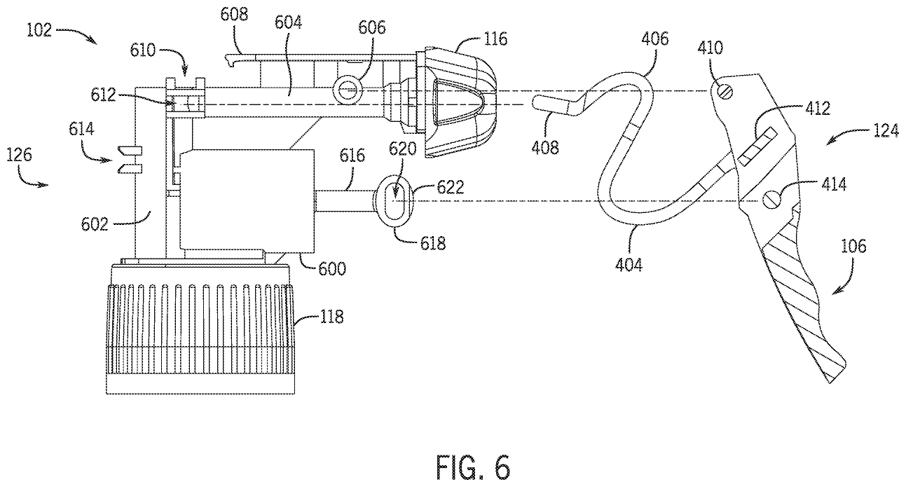

Referring specifically to the exploded view depicted in FIG. 3, the internal components of the trigger sprayer assembly 100 are shown. These internal components include an engine 102 with a piston chamber and a fluid outlet passage (e.g., see piston chamber 600, fluid outlet passage 602, 604 described in further detail below with reference to FIG. 6), and a piston component 104 that is coupled to the trigger component 106 and configured to slide within the piston chamber. As the trigger component 106 is depressed toward the rear end 126 of the assembly 100, the piston component 104 is likewise forced by the trigger lever component 106 toward the rear end 126, which decreases the volume of the piston chamber and forces fluid within the piston chamber into the fluid outlet passage 602, 604 within the engine 102 and out through the nozzle 116, provided that the nozzle 116 is rotated to an opened position. When the actuating force has been removed and the trigger lever component 106 relaxes toward the front end 124, the trigger lever component 106 pulls the piston 104 outwardly from the piston chamber, thereby increasing the volume of the piston chamber.

An input housing 108 is shown to be positioned below the engine 102. The input housing 108 may be configured to couple to a dip tube (not shown) that extends into the bottle or container of fluid and provides a path for the fluid to be drawn upwards into the sprayer assembly 100. The input housing 108 also provides a seat for a one-way input valve 110 that regulates a flow of fluid into the engine 102. In this exemplary embodiment, the input valve 110 has a generally cylindrical shape with a movable flap at an upper end. The input valve 110 may be fabricated from a flexible material (e.g., a thermoplastic elastomer) such that when fluid pressure within the dip tube exceeds a certain threshold, the movable flap lifts upwardly, permitting fluid to flow through the dip tube and into the engine 102. However, in other embodiments, any suitable style of one way valve (e.g., a ball valve) may be utilized.

A neck closure 118 is shown to be positioned below the input housing 108 and the one-way input valve 110. The neck closure 118 is configured to be utilized to couple the engine 102 to any desired bottle or container (not shown). As such, the dimensions of the neck closure (e.g., height, outer diameter, inner diameter) may be variable based on the size and shape of the bottle or container housing the liquid to be dispensed. In this exemplary embodiment, the neck closure 118 includes threads and is configured to be threadably coupled to a neck portion of the bottle or container. In other embodiments, the neck closure 118 is coupled to a neck portion of the bottle or container using a snap fit assembly process. A sealing gasket 120, shown positioned below the neck closure 118, may be utilized to ensure that fluid does not seep between the engine 102 and the input housing 108, and out through the neck closure 118, particularly in the case if the trigger sprayer assembly 100 is tilted or inverted.

Still referring to FIG. 3, the internal components of the trigger sprayer assembly 100 are also shown to include a nozzle valve 112 and a water jacket 114. The nozzle valve 112, like the input valve 110, may be a one-way valve that is configured to only permit the passage of fluid once a fluid pressure threshold is exceeded. In this exemplary embodiment, the nozzle valve 112 is a dual slit valve fabricated from a flexible material, although any suitable type of one-way valve may be utilized. The water jacket 114 may be configured to fit over the nozzle valve 112 and prevent the leakage of fluid at the joint between the engine 102 and the nozzle component 116, particularly in a case in which the trigger sprayer assembly 100 is tilted or positioned such that the nozzle component 116 faces downwardly.

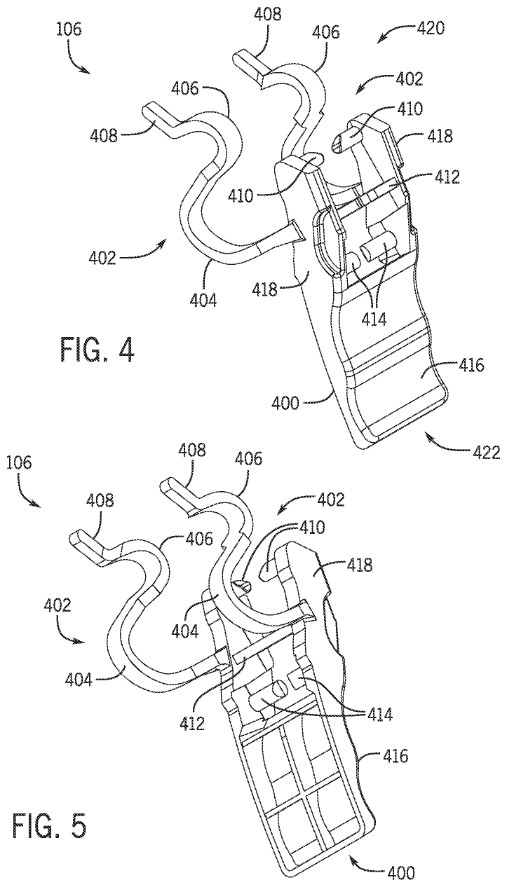

FIGS. 4 and 5 depict perspective views of the trigger lever component 106. The trigger lever component 106 is shown to include a main trigger body 400 with a pair of S-shaped springs 402 extending therefrom. The springs 402 are configured to be compressed as the trigger lever 106 is moved from the neutral position to the depressed position. When a user releases the actuating force, the potential energy stored in the springs 402 causes the trigger component 106 to return to the neutral position. Since the piston component 104 is coupled to the trigger lever 106, the return of the trigger component 106 to the neutral position pulls the piston component 104 out of the piston chamber, permitting liquid drawn upwardly through the dip tube to fill the piston chamber in preparation for subsequent actuation of the trigger lever 106.

Each of the S-shaped springs 402 includes a first curved portion 404, a second curved portion 406, and a terminating portion 408. The first curved portion 404 extends from the main trigger body 400 in a generally concave shape, while the second curved portion 406 extends from the first curved portion 404 in a generally convex shape. Existing springs for trigger sprayer assemblies are generally U-shaped, having either a generally convex or concave shape, but not both. The present inventors have recognized that S-shaped trigger springs with both concave and convex portions are less susceptible to fatigue damage and provide a smoother actuation feeling to the user. In the exemplary embodiment, the first curved portion 404 has a larger radius of curvature than the second curved portion 406 such that the first curved portion 404 compresses more easily than the second curved portion 406. As described in further detail below with reference to FIGS. 6 and 9-10, the terminating portions 408 of the springs 402 may be inserted in receiving regions (e.g., receiving regions 612) formed in the engine 102 such that the terminating portions 408 are constrained in the vertical direction while the first curved portion 404 and the second curved portion 406 are free to contract and expand with the motion of the main body trigger body 400. Horizontal movement of the terminating portions 408 (i.e., movement toward the front end 124 or the rear end 126) is not constrained.

The trigger lever component 106 is further shown to include a pair of pivot pins 410 extending inwardly from sidewalls 418 of the main trigger body 400 at an upper end 420. The pivot pins 410 are configured to engage recesses within the engine 102 (e.g., pivot recesses 606, depicted in FIG. 6) such that the pivot pins 410 act as a pivot point for the trigger component 106 to rotate relative to engine 102. In this exemplary embodiment, the pivot pins 410 are semi-flexible or otherwise configured to flex relative to the sidewalls 418 without fracture, and a sufficient lateral gap is provided between the pivot pins 410 to permit the pivot pins 410 to engage the pivot recesses using a snap fit assembly process. The pivot pins 410 may further include chamfered or beveled lead-in surfaces that ease the ability of the pivot pins 410 to snap fit into the recesses within the engine 102.

A strengthening rib 412 is shown to be disposed in the main trigger body 400 below the pivot pins 410. The strengthening rib 412 may protect the trigger component 106 from fracture during the process of assembling the trigger component 106, as well as fatigue damage as the trigger component 106 is actuated by a user. A pair of piston coupling pins 414 is shown to extend inwardly from sidewalls 418 of the main trigger body 400 below the strengthening rib 412. The piston coupling pins 414 are configured to engage with an opening (e.g., oval-shaped opening 620, depicted in FIG. 6) to couple the trigger lever component 106 to the piston component 104. Like the pivot pins 410, the piston coupling pins 414 are semi-flexible, and a sufficient lateral gap is provided between the piston coupling pins 414 to permit the coupling pins 414 to engage the piston component 104 using a snap fit assembly process. The piston coupling pins 414 may further include chamfered or beveled lead-in surfaces that ease the ability of the coupling pins 414 to snap fit into the recess 620 formed in the piston component 104.

Still referring to FIGS. 4 and 5, a lower end 422 of the main trigger body 400 is shown to include a contoured grip surface 416. The contours or grooves of the grip surface 416 may be configured to ensure the user of the trigger sprayer assembly 100 can comfortably position their fingers to actuate the trigger component 106. The contours of the grip surface 416 also prevent the user's fingers from sliding off the grip surface 416 if the trigger component 106 is wet and/or slippery.

In the exemplary embodiments shown in drawings, the trigger component 106 is fabricated from an injection molded thermoplastic, for example, polypropylene. The present inventors have recognized that polypropylene exhibits several desirable characteristics for use in trigger sprayer assemblies, including good stiffness, creep resistance, high impact resistance, and antistatic properties. In some embodiments, many of the other main components of the trigger sprayer assembly 100 may be fabricated from polypropylene using an injection molding process, including the engine 102, the piston 104, the neck closure 118, and the shroud 122. In other embodiments, the trigger component 106 is fabricated from a different material than other components of the trigger sprayer assembly 100, including the engine 102, the piston 104, the neck closure 118, and the shroud 122. For example, the trigger lever component 106 may be fabricated from a material that is more rigid and has higher strength in order to withstand actuation and spring forces that are not imposed on other components of the trigger assembly 100. In still further embodiments, the trigger component 106 can be fabricated from polyoxymethylene or polycarbonate, and the piston 104 can be fabricated from high density polyethylene (HDPE).

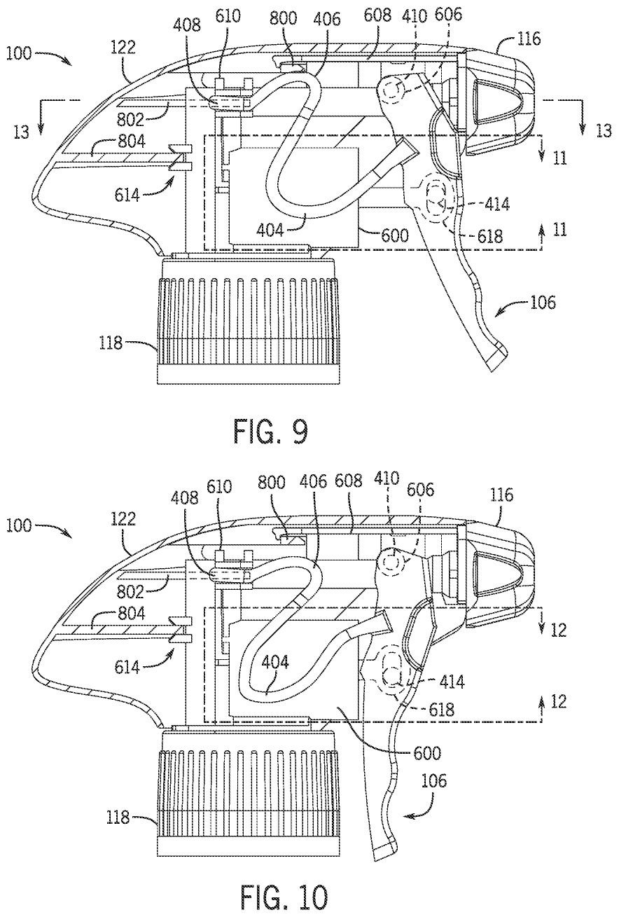

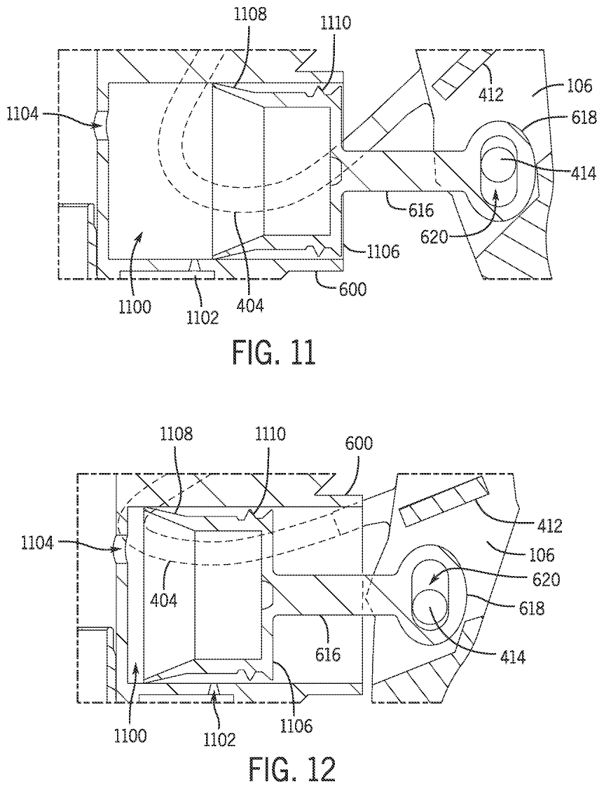

FIG. 6 depicts the features that permit the trigger component 106 to couple to the engine 102 and the piston component 104. Engine 102 is shown to include a generally cylindrically-shaped piston chamber 600, in which the piston component 104 is slidably disposed. Specifically, a plunger portion of the piston component 104 (plunger 1106, depicted in FIGS. 11 and 12) is configured to slide within the piston chamber 600 to control the volume of fluid within the piston chamber 600. In the shown embodiment, an inner diameter of the piston chamber 600 is approximately 15.5 mm, and the stroke of the piston component 104 is approximately 9.0 mm such that the liquid output per actuation of the trigger component 106 is at least 1.3 cubic centimeters (CC), and preferably between 1.6 and 1.7 CC. The actuation force to achieve this liquid output is preferably between 60 and 75 N. The piston component 104 is further shown to include an intermediate portion 616 in the form of a piston rod that is at least partially disposed outside of the piston chamber 600. In some embodiments, the intermediate portion 616 is generally rod shaped. In other embodiments, the intermediate portion 616 is a flange with one or more strengthening ribs that protect the intermediate portion 616 against fracture. The intermediate portion 616 terminates in an end portion 618 that has a generally oval-shaped cross section, and an oval-shaped opening 620. The pair of piston coupling pins 414 of the trigger component 106 are configured to be snap fit assembled to the piston component 104 such that the piston coupling pins 414 are free to vertically slide within the oval-shaped opening 620 as the trigger component 106 is moved between the neutral and depressed positions. Further details of the interaction between the piston coupling pins 414 and the oval-shaped opening 620 are included below with reference to FIGS. 9-12. In some embodiments, the end portion 618 includes one or more beveled surfaces 622 positioned at a leading end of the end portion 618 to ease the assembly of the piston coupling pins 414 into the oval-shaped opening 620.

The engine 102 further includes a vertical outlet passage portion 602 positioned at a rear end 126 of the assembly, and a horizontal outlet passage portion 604 positioned above the piston chamber 600 and the piston component 104. Vertical and horizontally-oriented fluid passages within the portions 602, 604 are fluidly coupled to the piston chamber 600. As the trigger lever 106 pivots from the neutral position to the depressed position, fluid located within the piston chamber 600 is first driven into the vertical outlet passage portion 602, and subsequently through the horizontal outlet passage portion 604 before exiting the engine 102 through the nozzle component 116.

Pivot recesses 606 are shown to be formed in the engine 102 between the piston chamber 600 and the nozzle component 116. The pivot recesses 606 may be any size or shape required to permit the pivot pins 410 to be assembled to the recesses 606 using a snap fit assembly process, and to permit the trigger lever 106 to pivot freely relative to the engine 102 once assembled so that the trigger lever component 106 can move between the neutral and depressed positions. In an alternative embodiment, the positions of the pivot pins and the pivot recesses may be reversed such that pivot pins protrude from the engine 102 and are configured to be received by recesses formed in the trigger lever 106.

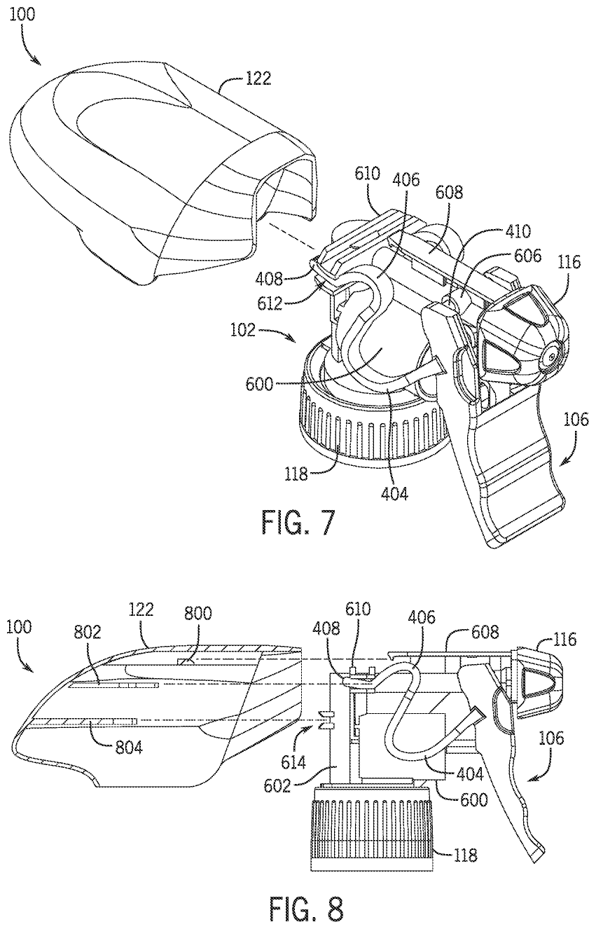

A shroud coupling rail 608 is shown to be positioned above the pivot recesses 606. As depicted in FIGS. 7 and 8 below, the shroud coupling rail 608 is used to align the shroud component 122 relative to the engine 102 and prevent disassembly of the shroud component 122 from the engine 102 once the components have been coupled. Between the vertical outlet passage portion 602 and the shroud coupling rail 608, the engine 102 is shown to include a spring coupling rail 610 with a pair of spring retention recesses 612. The terminating portions 408 of the S-shaped springs 402 are configured to fit within the retention recesses 612 such that the overall movement of the springs 402 is constrained in the vertical direction as the first and second curved portions 404, 406 are compressed and relaxed, although horizontal movement (i.e., toward the front end 124 or the rear end 126) is not constrained. By vertically constraining the springs 402 within the retention recesses 612 in the engine 102, the springs 402 remain optimally positioned within the shroud component 122 throughout the lifespan of the trigger assembly 100, and are not accessible to a user, thereby reducing or eliminating a risk that a user can damage the springs 402. Positioned at the rear end 126, the engine 102 is further shown to include a pair of shroud receiving clips 614. The shroud receiving clips 614 may extend from the vertical outlet passage portion 602 at the approximate vertical midpoint between the shroud coupling rail 608 and the joint between the engine 102 and the neck closure 118.

FIGS. 7 and 8 depict the coupling of the shroud 122 to the engine 102. Specifically, the shroud component 122 may be slid forwardly on the engine 102 toward the trigger lever 106 until coupling features arrest the movement of the shroud component 122 relative to the engine 102. In the shown embodiment, the shroud 122 includes features that couple to the engine 102 at multiple locations: an upper latching section 800 is configured to mate with the shroud coupling rail 608, a middle section 802 is configured to fit around the terminating portions 408 of the springs in the retention recesses 612, and a lower latching section 804 is configured to be received by the shroud receiving clips 614. Advantageously, these coupling features 800-804 may be easily incorporated into shroud components 122 having a variety of exterior geometries, thereby permitting the trigger sprayer assembly 100 to have a variety of appearances and designs.

FIGS. 9-12 depict cross-sectional views of the trigger sprayer assembly 100 in the relaxed or neutral position (FIGS. 9 and 11) and the depressed or actuated position (FIGS. 10 and 12). As shown in FIGS. 9 and 11, when the trigger component 106 is in the relaxed position, the piston coupling pins 414 are positioned near the top of the oval-shaped opening 620 of the end portion 618, although some clearance is maintained above the piston coupling pins 414. When the trigger component is moved to the depressed position, as shown in FIGS. 10 and 12, the piston coupling pins 414 slide downwardly in the oval-shaped opening 620, although some clearance is maintained below the piston coupling pins 414. The present inventors have recognized that providing a slotted opening 620 for the piston coupling pins 414 to travel relative to the end portion 618 of the piston prevents fracture of the piston component 104 in the case that excessive force is utilized in actuating the trigger lever 106. In addition, the slotted opening 620 guides the piston coupling pins 414, and thus the trigger component 106, back to an optimal neutral position in the case that a user applies a offset force (e.g., a jerking or pulling motion) that would otherwise dislocate and prevent smooth actuation of the trigger component 106. The actuating force provided by the user generally acts upon the first curved portions 404 of each trigger spring 402, rather than the second curved portion 406. As particularly shown in FIG. 10, the actuating force compresses and thereby causes visible deformation of the first curved portion 404, while the second curved portion 406 only experiences a small amount of rotation as compared with the unactuated position. Advantageously, this geometry ensures that the actuating force is distributed about the first curved portion 404 of each spring 402 having a larger radius of curvature and less stiffness than the second curved portion 406, thus protecting the springs 402 from fatigue damage and providing a smoother actuation to the user.

FIGS. 11 and 12 additionally depict the positions of a plunger portion 1106 of the piston component 104 as the trigger lever 106 is pivoted between the neutral and the depressed positions. The plunger portion 1106 is shown to have a flared end 1108 that contacts the sidewalls of the piston chamber 600 and is positioned opposite the end portion 618. In the shown embodiment, the plunger portion 1106 also includes one or more sealing ridges 1110 proximate the intermediate portion 616 to prevent the leakage of liquid from the piston chamber 600.

When the trigger component 106 is in the neutral position, as is depicted in FIG. 11, the volume 1100 of liquid within the piston chamber 600 is at a maximum, and the intermediate portion 616 is positioned fully outside of the piston chamber 600. When the trigger component 106 is in the depressed position, as is depicted in FIG. 12, the volume 1100 of liquid within the piston chamber 600 is at a minimum, and at least a part of the intermediate portion 616 of the piston is positioned within the piston chamber 600. As the trigger component 106 transitions from the neutral position to the depressed position (i.e., from the position depicted in FIG. 11 to the position depicted in FIG. 12), liquid within the piston chamber 600 is forced through an inlet/outlet passage 1104 by the plunger 1106 and into the vertical outlet portion 602 (depicted in FIG. 6). As the trigger component 106 transitions from the depressed position back to the neutral position (i.e, from the position depicted in FIG. 12 to the position depicted in FIG. 11), the piston chamber 600 is refilled with liquid that enters through the inlet/outlet passage 1104. A vent hole 1102 is shown to be formed in a wall defining the piston chamber 600 below the plunger portion 1106 of the piston component. The vent hole 1102 provides pressure equalization for the fluid container when the plunger portion 1106 is depressed. The vent hole 1102 also provides an outlet for residual liquid in the piston chamber 600 to drain into the fluid container when dispensing is complete.

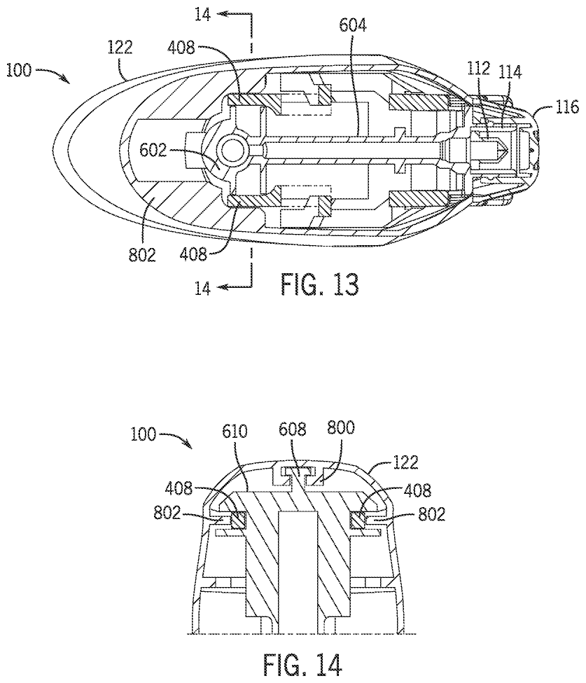

Referring now to FIGS. 13 and 14, additional top and front cross-sectional views of the trigger sprayer assembly 100 depicting the coupling of the engine 102 and the shroud component 122 are shown. As described above with reference to FIGS. 7 and 8, the engine 102 and the shroud component 122 include several features that facilitate this coupling. For example, the middle section 802 of the shroud component 122 is configured to fit around the terminating portions 408 of the springs as they are seated in the retention recesses of the engine 102. In addition, the upper latching section 800 is configured to mate with the shroud coupling rail 608.

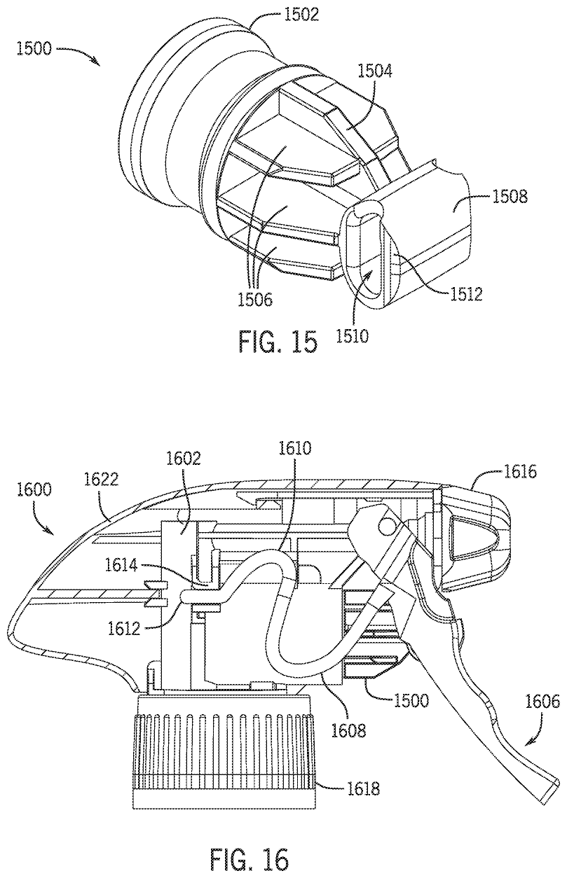

Turning now to FIG. 15, another embodiment of a piston component 1500 is depicted. Similar to the piston component 104, depicted and described above with reference to at least FIGS. 3, 11, and 12, the piston component 1500 is shown to include a plunger portion 1502 and an end portion 1508. Accordingly, the piston component 1500 may be used interchangeably with the piston component 104 in the trigger sprayer assembly 100. The end portion 1508 includes an oval-shaped opening 1510 and one or more beveled surfaces 1512 to ease the coupling of the piston component 1500 to a trigger lever component. However, rather than include a piston rod between the plunger portion 1502 and the end portion 1508, the piston component 1500 is shown to include a flange 1504 with multiple strengthening ribs 1506 positioned orthogonally to the flange 1504. The inclusion of the flange 1504 and strengthening ribs 1506 provides greater protection to the piston component 1500 against fatigue damage and fracture. The piston component 1500 may be particularly useful in applications that require pressurization and/or positional reorientation, for example, when dispensing hand soap.

FIG. 16 depicts another embodiment of a trigger sprayer assembly 1600. Similar to the trigger sprayer assembly 100, depicted and described above with reference to at least FIGS. 1-3, 9 and 10, the trigger sprayer assembly 1600 is shown to include an engine 1602, the piston component 1500, trigger lever 1606, nozzle component 1616, neck closure 1618, and shroud 1622. Some of these components, for example, the nozzle component 1616, the neck closure 1618, and the shroud 1622 are identical or substantially similar to the nozzle component 116, the neck closure 118, and the shroud 122 as described above. Other components are shown to include modifications from the component counterparts of the trigger sprayer 100. For example, a spring coupling rail 1614 of the engine 1602 is shown to be moved vertically downward relative to the spring coupling rail 602 of the engine 102. By lowering the position of the coupling between the spring coupling rail 602 and terminating portions 1612 of the trigger springs, the tension in a first curved portion 1608 and a second curved portion 1610 of the trigger springs is reduced, thereby potentially increasing the lifespan of the springs.

The different systems and methods described herein may be used alone or in combination with other systems and devices. Various equivalents, alternatives and modifications are possible within the scope of the appended claims.

What is claimed is:

1. A trigger sprayer assembly for dispensing a fluid, comprising:
an engine comprising a piston chamber and an outlet passage that is fluidly coupled to the piston chamber;
a piston comprising a plunger that is disposed within the piston chamber and an intermediate portion that extends from the plunger and terminates in an end portion;
a trigger lever comprising a main body and at least one piston coupling body; and
a pair of trigger springs coupled to the main body, each of the pair of trigger springs comprising a first curved portion, a second curved portion, and a terminating portion;
wherein the first curved portion has a first radius of curvature, the second curved portion has a second radius of curvature, and the first radius of curvature is larger than the second radius of curvature;
wherein the terminating portions of the pair of trigger springs are configured to fit within recesses formed in the engine;
wherein the at least one piston coupling body of the trigger lever engages with the end portion; and
wherein pivoting the trigger lever from a neutral position to an actuated position compresses each of the pair of trigger springs and pushes the plunger into the piston chamber to drive fluid out of the piston chamber and into the outlet passage.

2. The trigger sprayer assembly of claim 1, wherein the first curved portion is generally concave and the second curved portion is generally convex such that each of the trigger springs is S-shaped.

3. The trigger sprayer assembly of claim 1, wherein the first curved portion is integrally molded with and extends from the main body of the trigger lever, and wherein the second curved portion is positioned between the first curved portion and the terminating portion.

4. The trigger sprayer assembly of claim 1, wherein the end portion comprises an oval-shaped opening formed therethrough.

5. The trigger sprayer assembly of claim 4, wherein the at least one piston coupling body travels downwardly in the oval-shaped opening as the trigger lever moves from the neutral position to the actuated position.

6. The trigger sprayer assembly of claim 4, wherein the at least one piston coupling body comprises a pair of piston coupling pins extending from the main body, the pair of piston coupling pins configured to couple to the oval-shaped opening using a snap fit assembly process.

7. The trigger sprayer assembly of claim 1, wherein an actuation force required to pivot the trigger lever from the neutral position to the actuated position ranges from 60 N to 75 N.

8. The trigger sprayer assembly of claim 1, wherein a liquid output of the trigger sprayer assembly is at least 1.3 cc when the trigger lever pivots from the neutral position to the actuated position.

9. The trigger sprayer assembly of 1, wherein:
the trigger lever further comprises at least one pivot pin positioned above the at least one piston coupling body; and
the engine further comprises at least one pivot recess;
wherein the at least one pivot pin is configured to fit within the at least one pivot recess such that the trigger lever pivots relative to the engine when moving between the neutral position and the actuated position.

10. A trigger lever for a trigger sprayer assembly, comprising:
a main body extending from an upper end to a lower end, the lower end being configured to be grasped by a user to actuate the trigger sprayer assembly; and
a pair of trigger springs integrally molded with and extending from the upper end of the main body, each of the pair of trigger springs comprising a first curved portion, a second curved portion, and a terminating portion.

11. The trigger lever of claim 10, wherein the first curved portion is generally concave and the second curved portion is generally convex such that each of the trigger springs is S-shaped.

12. The trigger lever of claim 10, wherein:
the first curved portion has a first radius of curvature;
the second curved portion has a second radius of curvature; and
wherein the first radius of curvature is larger than the second radius of curvature.

13. The trigger lever of claim 12, wherein the first curved portion extends from the main body, and wherein the second curved portion is positioned between the first curved portion and the terminating portion.

14. The trigger lever of claim 10, further comprising at least one piston coupling body configured to couple to a piston using a snap fit assembly process.

15. The trigger lever of claim 14, further comprising at least one pivot pin positioned above the at least one piston coupling body.

16. A piston for a trigger sprayer assembly, comprising:
a plunger configured to slide within a piston chamber; and
an intermediate portion configured to extend from the plunger and terminate in an end portion;
wherein the end portion has an oval-shaped opening formed therethrough.

17. The piston of claim 16, wherein oval-shaped opening is configured to couple to at least one piston coupling body of a trigger lever using a snap fit assembly process.

18. The piston of claim 16, wherein the intermediate portion is a rod.

19. The piston of claim 16, wherein the plunger comprises a flared end positioned opposite the end portion.

20. The piston of claim 19, wherein the plunger further comprises at least one sealing ridge.
